(19) United States
(12) Patent Application Publication
(10) Pub. No.: US 2008/0297500 A1
(43) Pub. Date: Dec. 4, 2008

(54) DISPLAY DEVICE AND METHOD OF DRIVING THE SAME

(76) Inventor: Hirofumi KATO, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/118,891

(22) Filed: May 12, 2008

(30) Foreign Application Priority Data
May 30, 2007 (JP) 2007-143911

(51) Int. Cl. G09G 5/00

(52) U.S. Cl. 345/212

(57) ABSTRACT

Provided is a display device including a timing controller configured to generate a pulse of a start pulse signal (STH) once in every two frames. This configuration makes it possible to drive a source driver and a gate driver once in every two frames, and thereby to reduce power consumption. Moreover, when switching from a normal mode to a power saving mode, a personal computer only needs to turn on a power save control signal. Accordingly, it is possible to switch a liquid crystal display device into the power saving mode without causing distortion of a display screen.

### CROSS-REFERENCE TO RELATED APPLICATIONS

This application is based upon and claims the benefit of priority from Japanese Patent Application No. 2007-143911 filed on May 30, 2007; the entire contents of which are incorporated herein by reference.

### BACKGROUND OF THE INVENTION

1. Field of the Invention

The present invention relates to a technique for driving a display device with low power consumption.

2. Description of the Related Art

An operation with lower power consumption has been an important research issue for a mobile laptop computer configured to be driven by a battery. Naturally, a liquid crystal display device used in a mobile laptop computer also faces a demand for lower power consumption. In terms of a liquid crystal display device, various approaches for achieving lower power consumption have been made including optimization of a driving method, selection of a circuit material, and the like. For example, a typical method of reducing power consumption in a liquid crystal display device is to lower a frequency of a clock signal to be inputted thereto from a computer.

Meanwhile, there is a case of using a differential signal called LVDS (low voltage differential signaling) for an interface between a computer and a liquid crystal display device in order to meet a higher speed operating frequency and to reduce EMI (electromagnetic interference) associated with higher definition of a liquid crystal display device (see Japanese Patent Application Publication No. 2002-108293, for example). In the LVDS, an inputted clock signal is multiplied seven times with a PLL (phase-locked loop) circuit or a DLL (delay-locked loop) circuit inside a liquid crystal display device for sampling a high-speed differential input signal, and the multiplied signal is used as a sampling clock.

However, a considerable period of time (about 10 msec) is required for allowing the PLL circuit or the DLL circuit to follow frequency variation of the inputted clock signal. Accordingly, there may be a case where a drive circuit in the liquid crystal display device cannot load the inputted signal accurately immediately after the computer changes the frequency of the inputted clock signal to reduce power consumption, and thereby an image on the display device may be temporarily distorted.

### SUMMARY OF THE INVENTION

An object of the present invention is to provide a display device and a method of driving the display device, which is capable of reducing power consumption and switching to a power saving mode without causing image distortion.

A display device according to the present invention includes a display unit, a drive circuit, and a control circuit. The display unit includes multiple signal lines and multiple scan lines which are arranged in a matrix. The drive circuit is configured to apply image data to the signal lines and to apply scan signals to the scan lines. The control circuit is configured to input a power save signal indicating selective transmission of the image data, and to output the image data to the drive circuit at a rate of once in multiple frames when the power save signal is on.

According to the present invention, the control circuit outputs the image data to the drive circuit at the rate of once in multiple frames when the power save signal is on, so that the drive circuit only needs to be driven in a frame when the image data are inputted. As a result, it is possible to reduce power consumption. Moreover, an external device such as a computer, which is configured to output an image signal to the display device, can drive the display device in the power saving mode only by controlling the power save signal. As a result, it is not necessary to change a synchronizing signal and the like to be inputted to the display device. Hence it is possible to avoid distortion of a clock signal which is generated based on the inputted synchronizing signal.

### BRIEF DESCRIPTION OF THE DRAWINGS

FIG. 1 is a block diagram showing a configuration of a liquid crystal display device according to a first embodiment of the present invention.

FIG. 2 is a block diagram showing a configuration of a source driver in the liquid crystal display device shown in FIG. 1.

FIG. 3 is a circuit diagram showing a configuration of a gradation circuit in the liquid crystal display device shown in FIG. 1.

FIG. 4 is a timing chart showing an operation of the liquid crystal display device shown in FIG. 1 in a normal mode.

FIG. 5 is a timing chart showing an operation of the liquid crystal display device shown in FIG. 1 in a power saving mode.

FIG. 6A is a block diagram showing a configuration of a liquid crystal display device according to a second embodiment of the present invention.

FIG. 6B is a block diagram showing a configuration of a frequency dividing circuit in the liquid crystal display device shown in FIG. 6A.

FIG. 7 is a timing chart showing an operation of the liquid crystal display device shown in FIG. 6A in a power saving mode.

### DESCRIPTION OF THE PREFERRED EMBODIMENTS

### First Embodiment

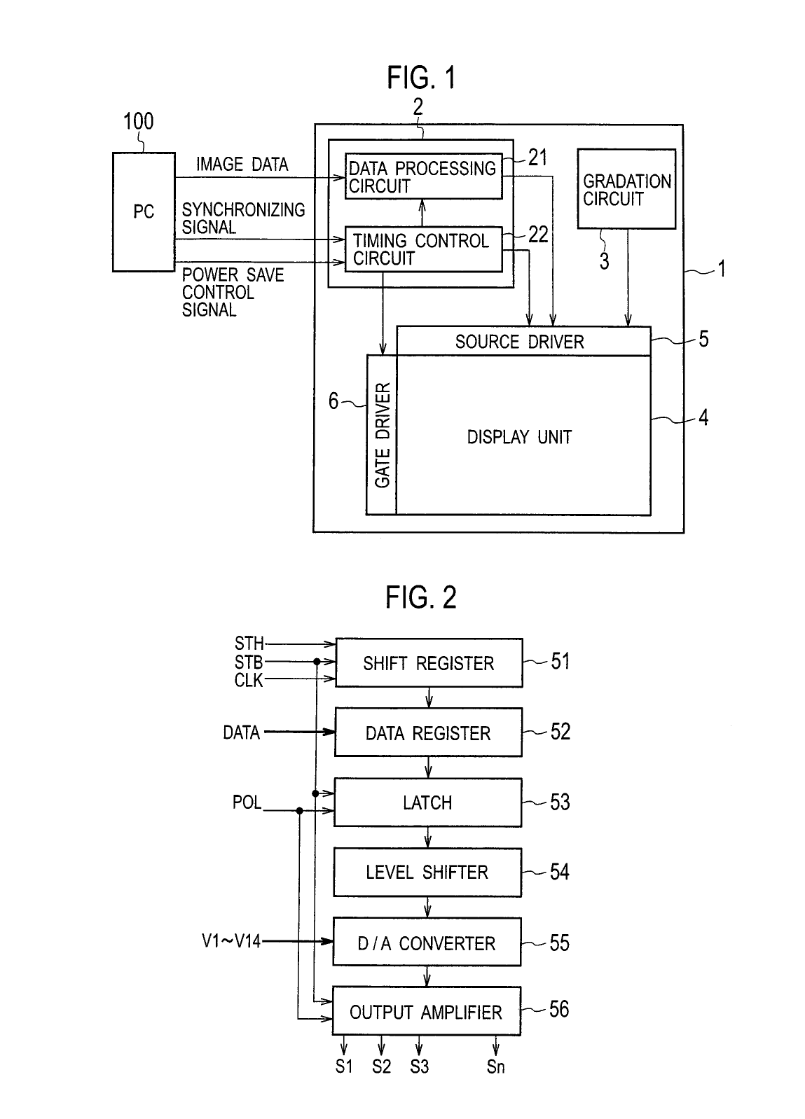

FIG. 1 is a block diagram showing a configuration of a liquid crystal display device according to a first embodiment of the present invention. A liquid crystal display device 1 includes: a timing controller 2 configured to input image data, a synchronizing signal, and a power save control signal from a personal computer (PC) 100; a gradation circuit 3 configured to generate a gradation reference voltage; a display unit 4 in which signal lines and scan lines are arranged in a matrix; a source driver 5 configured to output the inputted image data to the signal lines; and a gate driver 6 configured to output scan signals to the scan lines and to control timing to write the image data.

The timing controller 2 includes a data processing circuit 21 configured to receive and sort the image data in accordance with R (red), G (green), and B (blue) components of the display unit 4, and a timing control circuit 22 configured to receive the synchronizing signal and the power save control signal, and to control timing for the source driver 5 to load the image data. The timing controller 2 has a function to switch between a power saving mode and a normal mode based on the power save control signal received from the PC 100. The power saving mode will be described later.

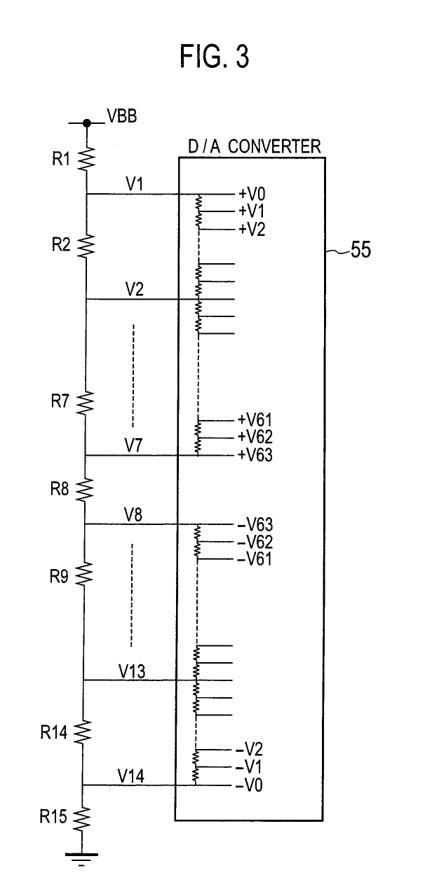

FIG. 2 is a block diagram showing a configuration of the source driver 5. FIG. 3 is a circuit diagram showing configurations of the gradation circuit 3 and of a DIA (digital to analog) converter 55. The source driver 5 includes: a shift register 51 configured to control timing for loading the image data; a data register 52 configured to load the image data; a latch circuit 53 configured to latch the data at designated timing; a level shift circuit 54; a DIA converter 55; and an output amplifier 56.

A start pulse signal (STH) for controlling timing to load the image data, a strobe signal (STB) for controlling timing to output the loaded image data, and a clock signal (CLK) are inputted to the shift register 51. The image data are inputted to the data register 52.

The shift register 51 loads the image data into the data register 52 in accordance with a pulse of the STH signal received from the timing controller 2. The image data loaded into the data register 52 passes through the latch circuit 53 and the level shift circuit 54 in accordance with the STB signal, and is converted into an analog signal by the DIA converter 55.

To the DIA converter 55, gradation reference voltages V1 to V14 generated by the gradation circuit 3 shown in FIG. 3 are supplied. In the DIA converter 55, the gradation reference voltages are further divided into voltages on positive and negative 64 levels. The D/A converter 55 selects an appropriate voltage out of the positive and negative 64 levels based on the received image data (6-bit digital data), and then outputs the selected voltage.

The image data converted into the analog signal is amplified to a sufficient voltage for driving the display unit 4 by using the output amplifier 56. The amplified image data corresponding to one line of the signal lines (S1, S2, S3, . . . , Sn) is outputted to the signal line.

Note that, in order to drive a liquid crystal part by an alternating current, a polarity inversion signal (POL) is inputted to the latch circuit 53 and the output amplifier 56.

The display unit 4 includes multiple signal lines and multiple scan lines which are arranged in a matrix. A pixel electrode of TFT (thin film transistor) is disposed on an intersection of each of the signal line and scan line to constitute a pixel. The TFT is turned on and the image data is written into the pixel, in response to the image data applied to the signal line by the source driver 5 and the scan signal applied to the scan line by the gate driver 6.

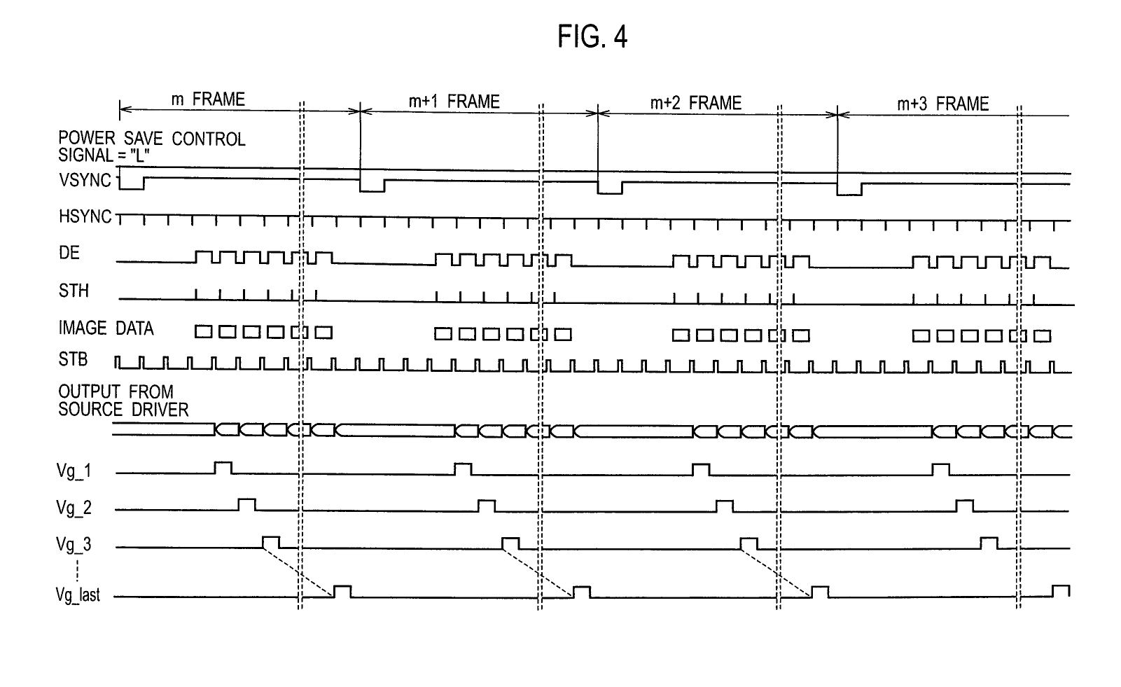

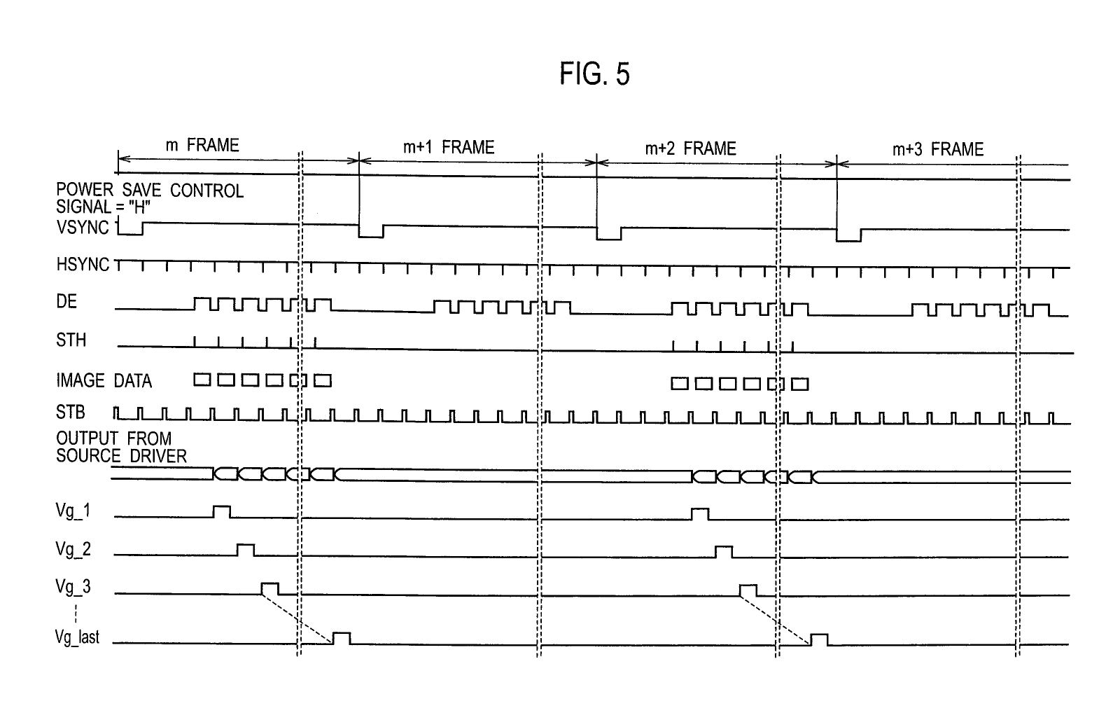

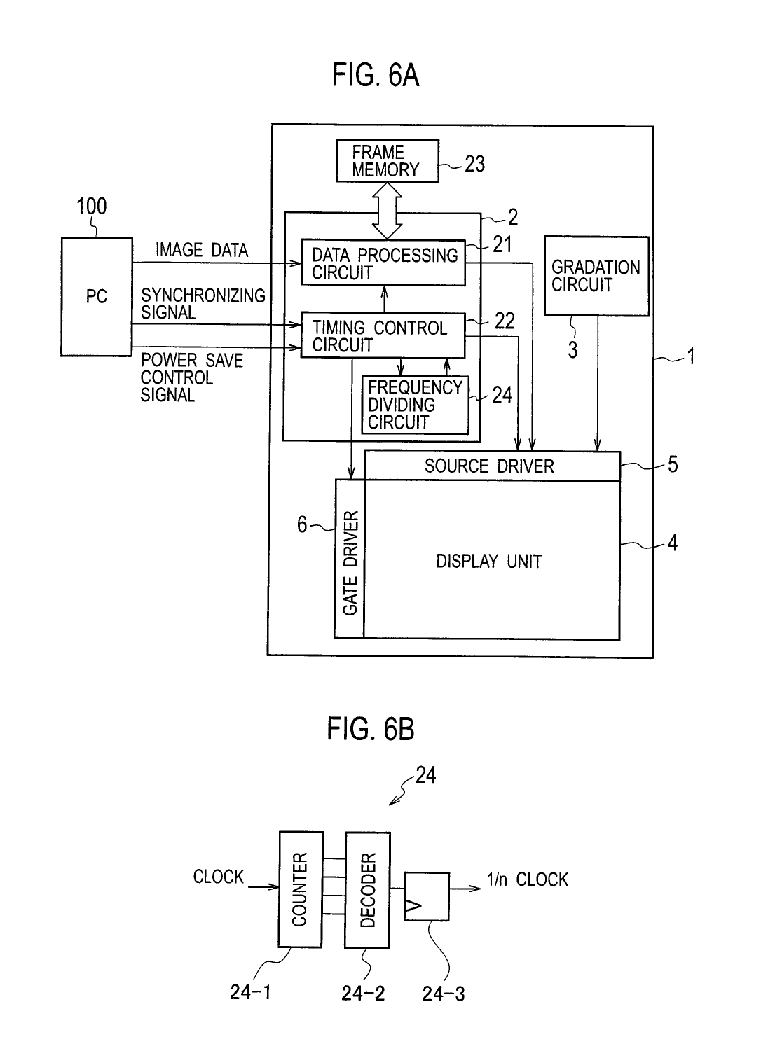

Next, operations of the liquid crystal display device of this embodiment will be described with reference to the accompanying drawings. FIG. 4 is a timing chart showing an operation in the normal mode and FIG. 5 is a timing chart showing an operation in the power saving mode. FIG. 4 and FIG. 6 show the signals to be outputted from the PC 100 to the timing controller 2, the signals to be outputted from the timing controller 2, the signal to be outputted from the source driver 5, and the signals to be outputted from the gate driver 6.

The PC 100 outputs to the timing controller 2 the power save control signal, a VSYNC signal (a vertical synchronizing signal), an HSYNC signal (a horizontal synchronizing signal), a DE signal (a data enable signal), and the image data. The timing controller 2 outputs to the source driver 5 the STH signal, the STB signal, and the image data. The source driver 5 outputs the image data for one line to the corresponding signal line. The gate driver 6 outputs the scan signals (Vg1, Vg2, Vg3, . . . , Vglast) to the scan lines.

Firstly, the operation in the normal mode will be described with reference to FIG. 4. In this description, the power save control signal is assumed to be set to a low (L) level indicating that the power saving mode is “off”. The PC 100 outputs the image data corresponding to one screen page sequentially in the order of an m frame, an m+1 frame, an m+2 frame, and an m+3 frame while defining a cycle of the VSYNC signal as a frame unit. The PC 100 outputs the image data corresponding to one screen page in one frame sequentially on a line basis from the first line to the last line at the same cycle as the HSYNC signal while turning on the DE signal.

The timing controller 2 generates a pulse of the STH signal at the same cycle as the HSYNC signal. The shift register 51 loads the image data into the data register 52 using the pulse of the STH signal as a trigger.

The timing controller 2 turns on the STB signal after loading of the image data for one line is finished. When the STB signal is on, the source driver 5 converts the image data into the analog signal and outputs the signal to the corresponding signal line. The gate driver 6 turns on the scan signal corresponding to the outputted image data and thereby writes the outputted image data into the respective pixels.

This series of operations is repeatedly executed from the first line to the last line, whereby the image data corresponding to one screen page is written into the display unit 4.

Subsequently, the operation in the power saving mode will be described with reference to FIG. 5. The operation in the power saving mode is different from that in the normal mode in that the source driver 5 and the gate driver 6 are driven once in every two frames.

The signals outputted from the PC 100 are the same as those outputted in the operation in the normal mode except that the power save control signal is set to a high (H) level indicating “on” state of the power saving mode. Accordingly, duplicate description will be omitted here.

As shown in the m+1 frame and the m+3 frame in FIG. 5, the timing controller 2 does not generate pulses of the STH signal once in every two frames. In the frame where pulses of the STH signal are not generated, the source driver 5 does not load the image data and the gate driver 6 does not turns the scan signals on. As a result, the screen page is rewritten once in every two frames in the display unit 4.

As has been described thus far, according to this embodiment, the source driver 5 and the gate driver 6 are only necessary to be driven once in every two frames by providing the timing controller 2 configured to generate pulses of the STH signal once in every two frames. In this way, it is possible to reduce power consumption. Moreover, when switching the normal mode to the power saving mode, the PC 100 only needs to turn on the power save control signal. Accordingly, it is possible to switch the liquid crystal display device 1 into the power saving mode without causing distortion of a display screen.

It should be noted that, although the operation of rewriting the screen page is performed once in every two frames in this embodiment, the present invention is not limited only to this configuration. For example, it is also possible to rewrite the screen page once in every three or more frames.

Moreover, in this embodiment, the PC 100 outputs the image data to the liquid crystal display device 1 even in the m+1 frame and the m+3 frame where the rewriting operation of the screen page is not performed. However, in the frames where the rewriting operation is omitted such as in the m+1 frame or the m+3 frame, it is also possible to output only the synchronizing signal to the liquid crystal display device 1 so that the PC 100 can omit the output of the image data.

### Second Embodiment

FIGS. 6A and 6B are block diagrams showing configurations of a liquid crystal display device according to a second embodiment of the present invention. The liquid crystal display device 1 shown in FIG. 6A is different from that illustrated in FIG. 1 in that a frame memory 23 and a frequency dividing circuit 24 configured to divide a clock frequency are further provided. The frame memory 23 is a memory configured to temporarily store the image data received from the PC 100 in the power saving mode. In the frame memory 23, the image data corresponding to one screen page can be stored. In the power saving mode, the data processing circuit 21 stores the image data received from the PC 100 into the frame memory 23. Then, the image data is read out of the frame memory 23 and is outputted to the source driver 5 based on a clock signal having a lower frequency than that of the clock signal received from the PC 100. This clock signal having the lower frequency is generated by the frequency dividing circuit 24 based on the clock signal received from the PC 100. As shown in FIG. 6B, the frequency dividing circuit 24 includes a counter 24-1, a decoder 24-2, and an amplifier 24-3.

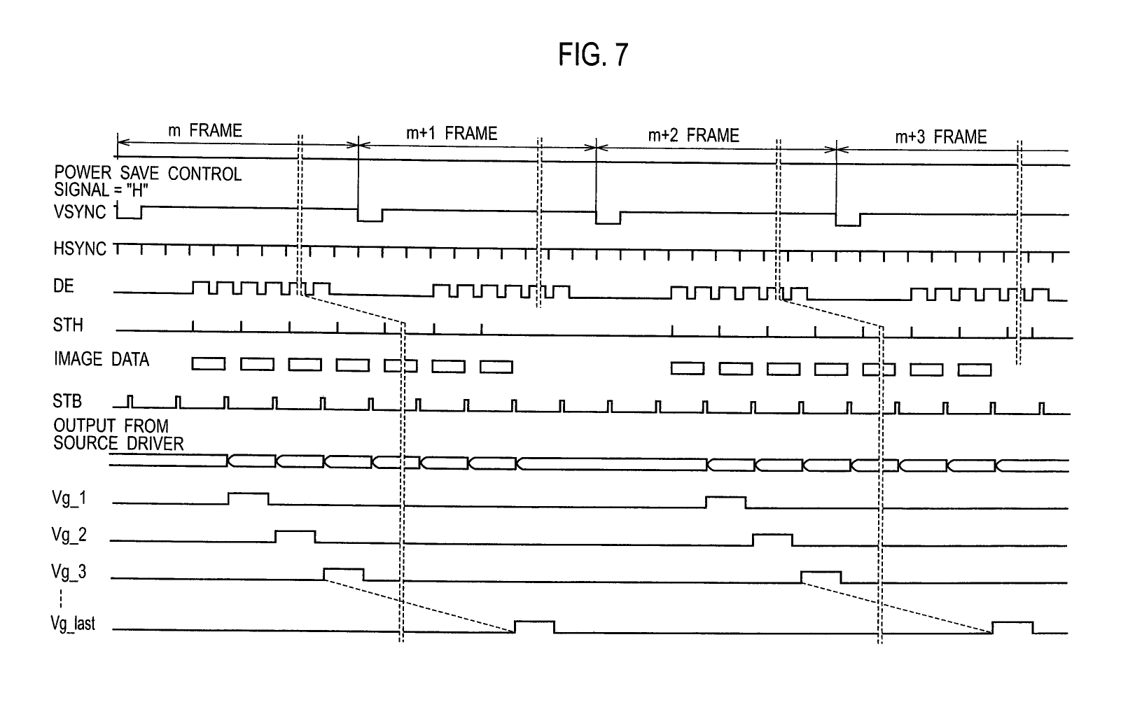

Next, an operation of the liquid crystal display device in the power saving mode of this embodiment will be described. The operation in the normal mode is the same as that of the liquid crystal display device in the first embodiment, and therefore duplicate description will be omitted. FIG. 7 is a timing chart showing the operation in the power saving mode. The signals to be outputted from the PC 100 are the same as those to be outputted in the normal mode except that the power save control signal is on (H).

The data processing circuit 21 stores the image data corresponding to one frame, which are received from the PC 100 on a line basis in accordance with the cycle of the HSYNC signal, into the frame memory 23.

When the image data corresponding to one frame is completely written into the frame memory 23, the timing controller 2 generates pulses of the STH signal so that a cycle thereof may be longer than that of the HSYNC signal. To be more precise, in the case of performing control such that two frames constitute one screen page, for example, one pulse of the STH signal is generated in a period for two pulses of the HSYNC signal. The clock signal to be outputted to the source driver 5 and the gate driver 6 is also generated at a lower frequency than that in the normal mode. By setting intervals between the pulses of the STH signal longer than that in the normal mode, it is possible to reduce the frequency of the clock signal for driving the source driver 5 and the gate driver 6 and thereby to reduce operating speeds of the source driver 5 and the gate driver 6.

The source driver 5 reads the image data out of the frame memory 23 at a low speed based on the STH signal and outputs the image data to the display unit 4 based on the STB signal. The cycle of the STB signal is also set to be longer than that in the normal mode as similar to that of the STH signal.

The gate driver 6 outputs the scan signals (Vg1, Vg2, Vg3, . . . , Vlast), which are controlled in conformity to the output of the image data from the source driver 5, to the scan lines.

Since the intervals between the pulses of the STH signal are extended so as to output the image data to the source driver 5 over a two-frame period, the image data corresponding to the m+1 frame and the m+3 frame outputted from the PC 100 are omitted as shown in FIG. 7. As a result, the image data corresponding to these frames are not loaded into the liquid crystal display device 1.

As has been described thus far, according to this embodiment, the frame memory 23 configured to store the image data corresponding to one screen page is provided so that the inputted image data may be temporarily stored in the frame memory 23 in the power saving mode. Moreover, the image data are outputted to the source driver 5 at a lower speed than that in the normal mode. In this way, it is possible to drive the source driver 5 and the gate driver 6 while reducing the operating speeds, and thereby to reduce power consumption. Further, when switching from the normal mode to the power saving mode, the PC 100 only needs to turn on the power save control signal, and the frequency dividing circuit 24 does not require lock-up time unlike the PLL circuit. Accordingly, it is possible to switch the liquid crystal display device 1 into the power saving mode without causing distortion of the display screen.

It should be noted that, in the second embodiment, it is also possible to apply modifications as similar to those in the first embodiment, such as rewriting the screen page once in every three or more frames, or stopping transmission of the image data during the omitted frames.

What is claimed is:

1. A display device comprising:
a display unit including a plurality of signal lines and a plurality of scan lines arranged in a matrix;
a drive circuit configured to apply image data to the signal lines and to apply scan signals to the scan lines; and
a control circuit configured to receive a power save signal that indicates selective transmission of the image data to the drive circuit, and to output the image data to the drive circuit at a rate of once in a plurality of frames when the power save signal is on.

2. The display device according to claim 1,
wherein the control circuit controls to omit transmission of the image data corresponding to a certain frame when the power save signal is on.

3. The display device according to claim 1,
wherein the control circuit comprises a storage unit,
the control circuit stores the image data into the storage unit when the power save signal is on, and
the control circuit reads the image data out of the storage unit at a longer cycle than a time period used for storage and outputs the image data to the drive circuit.

4. A method of driving a display device including: a display unit including a plurality of signal lines and a plurality of scan lines arranged in a matrix; a drive circuit configured to apply image data to the signal lines and to apply scan signals to the scan lines; and a control circuit configured to be controlled based on a power save signal so as to transmit the image data selectively to the drive circuit, the method comprising the step of
causing the control circuit to output the image data to the drive circuit at a rate of once in a plurality of frames when the power save signal is on.

5. The method of driving a display device according to claim 4,
wherein the control circuit comprises a storage unit,
the control circuit stores the image data into the storage unit when the power save signal is on, and
the control circuit reads the image data out of the storage unit at a longer cycle than a time period used for storage and outputs the image data to the drive circuit.
